(19) United States
(12) Patent Application Publication
(10) Pub. No.: US 2007/0046730 A1
(43) Pub. Date: Mar. 1, 2007

(54) INKJET PRINTHEAD AND METHOD OF MANUFACTURING THE SAME

(76) Inventors: Jae-sik MIN, Suwon-si (KR); Byung-ha PARK, Suwon-si (KR); Kyong-il KIM, Seoul (KR); Young-ung HA, Suwon-si (KR)

Correspondence Address: STANZIONE & KIM, LLP, 919 18TH STREET, N.W., SUITE 440, WASHINGTON, DC, 20006, US

(21) Appl. No.: 11/457,629

(22) Filed: Jul. 14, 2006

(30) Foreign Application Priority Data
Aug. 27, 2005 (KR) 2005-79131

(51) Int. Cl. B41J 2/05

(52) U.S. Cl. 347/61

(57) ABSTRACT

An inkjet printhead and a method of manufacturing the same. In the inkjet printhead, a substrate includes an ink chamber formed in a top surface to contain ink to be ejected, an ink feedhole formed in a bottom surface to supply the ink to the ink chamber, and a restrictor formed between the ink chamber and the ink feedhole to connect the ink chamber and the ink feedhole. A plurality of passivation layers are formed on the substrate. A heater and a conductor applying current to the heater are formed between the passivation layers. An epoxy nozzle layer is formed of a thermally conductive epoxy to cover the passivation layers. The epoxy nozzle layer is formed with a nozzle connected to the ink chamber.

### CROSS-REFERENCE TO RELATED APPLICATIONS

This application claims the benefit of Korean Patent Application No. 10-2005-0079131, filed on Aug. 27, 2005, in the Korean Intellectual Property Office, the disclosure of which is incorporated herein in its entirety by reference.

### BACKGROUND OF THE INVENTION

1. Field of the Invention

The present general inventive concept relates to an inkjet printhead and a method of manufacturing an inkjet printhead, and more particularly, to a back-shooting type inkjet printhead that has improved ink-ejection characteristics by effectively dissipating heat generated from a heater, and to a method of manufacturing a back-shooting type inkjet printhead.

2. Description of the Related Art

Generally, an inkjet printhead is a device for printing a color image on a printing medium by firing droplets of ink onto a desired region of the printing medium. There are two types of inkjet printers: a shuttle type inkjet printer and a line printing type inkjet printer. The shuttle type inkjet printer has an inkjet printhead that prints an image while the printhead moves in a direction perpendicular to the feeding direction of the printing medium. The line printing type inkjet printer is a newly developed, high speed printer that has an array printhead having a width corresponding to the width of a printing medium. The array printhead includes a plurality of inkjet printheads that are arranged in a predetermined pattern. In the line printing type inkjet printer, the array printhead is fixed and a printing medium is fed for printing, so that high speed printing can be realized.

Inkjet printheads can be classified into two types according to the ejecting mechanism of droplets of ink: thermal type inkjet printheads which create bubbles with heat to eject droplets of ink by the expansion of a bubble, and piezoelectric type inkjet printheads which include a piezoelectric material to eject droplets of ink by utilizing pressure generated by deformation of the piezoelectric material.

The ink droplet ejecting mechanism of the thermal printhead will now be more fully described. When a pulse current is applied to a heater formed of a resistive heating material, heat is generated from the heater to immediately increase the temperature of adjoining ink to about 300° C. As a result, a bubble is created, and the bubble, as it expands, exerts a pressure on the ink filled in an ink chamber. This pushes the ink out of the ink chamber through a nozzle in the form of a droplet.

Thermal type inkjet printheads can be divided into three types depending on the growing direction of the bubble and the ejecting direction of the droplets of ink: a top-shooting type inkjet printhead, a side-shooting type inkjet printhead, and a back-shooting type inkjet printhead. The growing direction of bubbles and the ejecting direction of droplets of ink are the same in the top-shooting type inkjet printhead, perpendicular to each other in the side-shooting type inkjet printhead, and opposite to each other in the back-shooting type inkjet printhead.

FIG. 1 illustrates side sectional view of an inkjet printhead disclosed in U.S. Pat. No. 5,841,452 as an example of a conventional back-shooting type inkjet printhead.

Referring to FIG. 1, an ink chamber 15 is formed in an upper portion of a substrate 10 to contain ink to be ejected, and an ink feedhole 17 is formed in a lower portion of the substrate 10 to supply ink to the ink chamber 15. Between the ink chamber 15 and the ink feedhole 17, a restrictor 13 is formed in a direction perpendicular to the surface of the substrate 10 to connect the ink chamber 15 and the ink feedhole 17. A nozzle plate 20 is stacked on the substrate 10, and the nozzle plate 20 is formed with a nozzle 21 to eject an ink droplet 30. The nozzle plate 20 includes a silicon oxide layer 23 formed on a surface of the substrate 10, heaters 22 formed on the silicon oxide layer 23 around the nozzle 21, and a passivation layer 25 protecting the heaters 22. In the passivation layer 25, thermal shunts 24 are provided to dissipate heat accumulated around the heaters 22 toward the substrate 10 after the ink is ejected.

In the above-described inkjet printhead, however, remaining heat after the ink is ejected by the heater 22 is dissipated toward the substrate 10 through the silicon oxide layer 23, which has a low thermal conductivity. Therefore, a large amount of heat is accumulated in the nozzle plate 20 after the ink is ejected, which increases the temperature of the ink in the ink chamber 15, thereby changing the viscosity of the ink and deteriorating the ejection characteristics of the ink.

Further, recently, the line printing type inkjet printers have been actively developed to satisfy the demand for high integration of the printhead and for high speed printing. Such line printing type inkjet printers generally employs an array printhead having a plurality of inkjet printheads. Since the array printhead is provided with a plurality of heaters, heat generated from the heaters and accumulated around the heaters is considerably large. Therefore, if the above-described conventional inkjet printheads are used for the array printheads, the ink ejection characteristics of the array printheads are deteriorated severely.

### SUMMARY OF THE INVENTION

The present general inventive concept provides a back-shooting type inkjet printhead that has improved ink ejecting characteristics by effectively dissipating heat generated from a heater, and a method of manufacturing a back-shooting type inkjet printhead.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an inkjet printhead including a substrate including an ink chamber formed in a top surface to contain ink to be ejected, an ink feedhole formed in a bottom surface to supply the ink to the ink chamber, a restrictor formed between the ink chamber and the ink feedhole to connect the ink chamber and the ink feedhole, a plurality of passivation layers formed on the substrate, a heater and a conductor that are formed between the passivation layers, and an epoxy nozzle layer formed of a thermally conductive epoxy to cover the passivation layers, wherein the epoxy nozzle layer is formed with a nozzle connected to the ink chamber.

The passivation layers may define a thermal plug therethrough to expose the top surface of the substrate, and the epoxy nozzle layer may be in contact with the substrate through the thermal plug.

The passivation layers may define a nozzle via hole therethrough in alignment with the nozzle, and the epoxy nozzle layer may be formed to cover an inner wall of the nozzle via hole.

The thermal conductive epoxy may be a photosensitive epoxy containing thermally conductive nanoparticles. The thermally conductive nanoparticles may be formed of metal such as Ag or ceramic such as aluminum nitride (AlN). The epoxy nozzle layer may have a thickness of 20 μm to 30 μm.

The passivation layers may include a first passivation layer and a second passivation layer that are sequentially stacked on the substrate, the heater may be formed between the first and second passivation layers, and the conductor may be formed between the heater and the second passivation layer. The first and second passivation layers may be formed of silicon oxide or silicon nitride.

The restrictor may be formed on the same plane as the ink chamber. The ink chamber and the restrictor may include inner walls formed with oxide layers.

The nozzle may have a taper shaped side section that becomes narrower toward an exit end of the nozzle.

The foregoing and/or other aspects and utilities of the present general inventive concepts are also achieved by providing a method of manufacturing an inkjet printhead, the method including forming a trench in a top surface of an substrate to define an ink chamber and a restrictor, and forming an oxide layer on the top surface of the substrate including an inner wall of the trench, filling the trench with a sacrificial layer being formed of a predetermined material, stacking passivation layers on the substrate and the sacrificial layer and forming a heater and a conductor between the passivation layers, patterning the passivation layers to form a nozzle via hole exposing a top surface of the sacrifice layer and a thermal plug exposing the top surface of the substrate forming an epoxy nozzle layer of a thermally conductive epoxy to cover the passivation layers wherein the epoxy nozzle layer defines a nozzle therethrough in alignment with the nozzle via hole to expose the top surface of the sacrificial layer, forming an ink feedhole by etching a bottom surface of the substrate to expose the oxide layer formed on a bottom of the trench, forming the ink chamber and the restrictor by removing the sacrifice layer exposed through the nozzle, and removing a portion of the oxide layer that is located between the ink feedhole and the restrictor.

The filling of the trench may include growing the polysilicon on the oxide layer of the substrate using an epitaxial method to fill the trench and planarizing a top surface of the polysilicon through a CMP (chemical mechanical polishing) process to expose the top surface of the substrate.

The formation or stacking of the passivation layers and the forming of the heater and the conductor may include forming a first passivation layer on the top surfaces of the substrate and the sacrifice layer, forming the heater on a top surface of the first passivation layer and forming the conductor on a top surface of the heater, and forming a second passivation layer on the top surface of the first passivation layer to cover the heater and the conductor.

The forming of the epoxy nozzle layer may include coating the passivation layers with the thermally conductive epoxy to fill the nozzle via hole and the thermal plug, and forming the nozzle in alignment with the nozzle via hole by patterning the thermally conductive epoxy through a lithographic process.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a side sectional view illustrating an example of a conventional back-shooting type inkjet printhead;

FIG. 2 is a plan view schematically illustrating an inkjet printhead according to an embodiment of the present general inventive concept;

FIG. 3 is an enlarged view of portion A in FIG. 2;

FIG. 4 is a sectional view taken along line IV-IV′ of FIG. 3;

FIG. 5 is a sectional view taken along line V-V′ of FIG. 3;

FIG. 6 is an enlarged view of portion B in FIG. 5; and

FIGS. 7A through 7H show a method of manufacturing an inkjet printhead according to an embodiment of the present general inventive concept.

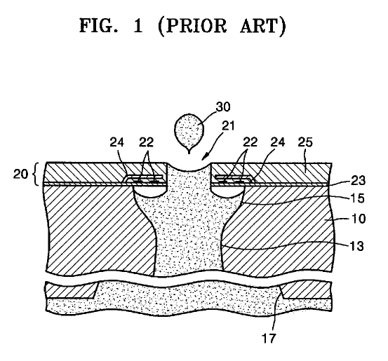

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

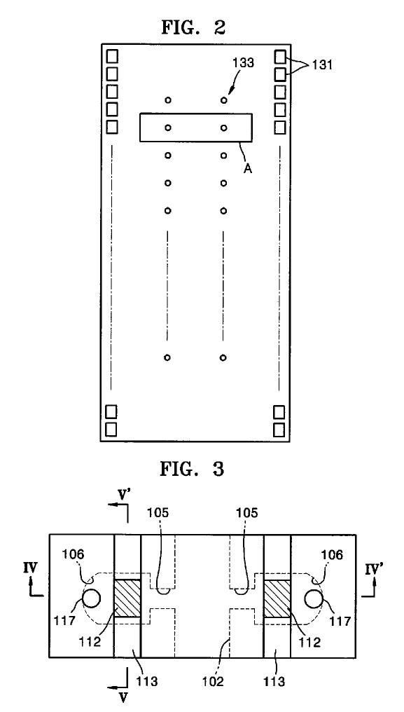

FIG. 2 is a plan view schematically illustrating an inkjet printhead according to an embodiment of the general inventive concept. Referring to FIG. 2, the inkjet printhead includes ink ejection portions 133 arranged vertically in two rows and bonding pads 131 arranged in electrical connection with the respective ink ejection portions 133. Though the ink ejection portions 133 are arranged in two rows in FIG. 2, the ink ejection portions 133 can be arranged in one row, or in three or more rows to increase resolution.

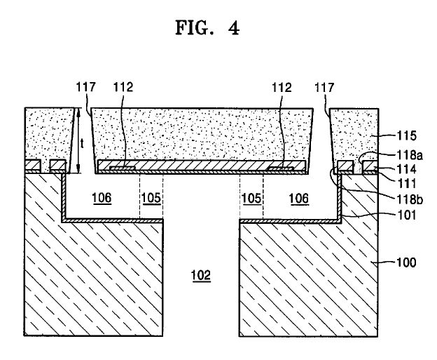

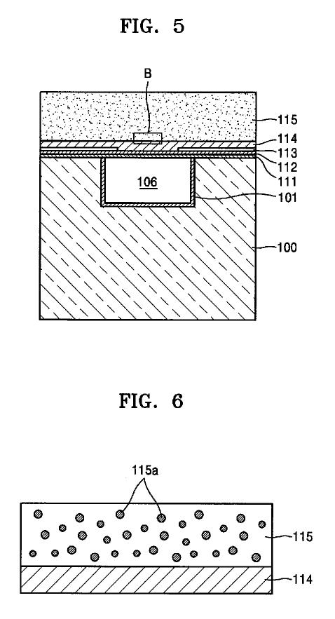

FIG. 3 is an enlarged view of portion A in FIG. 2, FIG. 4 is a sectional view taken along line IV-IV′ of FIG. 3, FIG. 5 is a sectional view taken along line V-V′ of FIG. 3, and FIG. 6 is an enlarged view of portion B in FIG. 5.

Referring to FIGS. 3 through 5, ink chambers 106 are formed in a top surface of a substrate 100 at a preset depth to contain ink to be ejected, and an ink feedhole 102 is formed in a bottom surface of the substrate 100 to supply the ink to the ink chambers 106. Generally, the substrate 100 may be formed of a silicon wafer. Between the ink chambers 106 and the ink feedhole 102, restrictors 105 are formed to connect the ink chambers 106 with the ink feedhole 102. The restrictors 105 may be formed parallel to a top surface of the substrate 100 on the same plane as the ink chambers 106. Meanwhile, an oxide layer 101 including a silicon oxide layer is formed on inner walls of the ink chambers 106 and the restrictor 105.

A plurality of passivation layers 111 and 114 are formed on the substrate 100 in which the ink chambers 106, the restrictors 105, and the ink feedhole 102 are formed. Heaters 112 and conductors 113 are formed between the passivation layers 111 and 114. The heaters 112 heat the ink in the ink chambers 106 to create bubbles, and the conductors 113 apply current to the heaters 112. In detail, a first passivation layer 111 is formed on the substrate 100 to form upper walls of the ink chambers 106. The first passivation layer 111 is a material layer to provide protection to the heaters 112 and insulation between the heaters 112 and the substrate 100. The first passivation layer 111 may be formed of silicon oxide or silicon nitride.

On the first passivation layer 111 formed above the ink chambers 106, the heaters 112 are formed. The number of the heaters 112 may correspond to that of the ink chambers 106. The locations and shapes of the heaters 112 may optionally be changed different from those illustrated in drawings. The heaters 112 may be formed of a resistive heating material such as tantalum-aluminum alloy, tantalum nitride, titanium nitride, or tungsten silicide. The conductors 113 are formed on a top surface of the heaters 112 in electrical connection with the heaters 112 to supply current to the heaters 112. The conductors 113 may be formed of material having a high electrical conductivity, for example, aluminum (Al), aluminum alloy, gold (Au), or silver (Ag).

A second passivation layer 114 is formed on a top surface of the first passivation layer 111 to cover the heater 112 and the conductor 113. The second passivation layer 114 is a material layer protecting the heaters 112 and the conductors 113, and may be formed of silicon oxide or silicon nitride. Meanwhile, the first and second passivation layers 111 and 114 define nozzle via holes 118b aligned with nozzles 117 (described later). Further, thermal plugs 118a are formed through the first and second passivation layers 111 and 114 at both sides of the substrate 100 to expose the substrate 100.

An epoxy nozzle layer 115 is formed on the first and second passivation layers 111 and 114. The epoxy nozzle layer 115 fills the thermal plugs 118a to make contact with the top surface of the substrate 100 through the thermal plugs 118a. The epoxy nozzle layer 115 may have a thickness (t) of about 20 μm to 30 μm. The epoxy nozzle layer 115 is formed of a thermally conductive epoxy. Specifically, the epoxy nozzle layer 115, as illustrated in FIG. 6, may be formed of a photosensitive epoxy containing nanoparticles 115a having a high thermal conductivity, such as, metal (e.g., Ag) nanoparticles or ceramic (e.g., aluminum nitride (AlN)) nanoparticles. As mentioned above, in this embodiment, the epoxy nozzle layer 115 is formed of a thermally conductive epoxy, such that heat generated from the heaters 112 can be rapidly dissipated to the substrate 100 through the epoxy nozzle layer 115, thereby improving ink ejection characteristics.

Further, the epoxy nozzle layer 115 can cover inner walls of the nozzle via holes 118b formed in the first and second passivation layers 111 and 114. Therefore, the epoxy nozzle layer 115 defines nozzles 117 therethrough in alignment with the nozzle via holes 118b. Each of the nozzles 117 can have a tapered shape that becomes narrower toward an exit end thereof to quickly stabilize a meniscus formed in the surface of the ink after ejection thereof. The thermally conductive epoxy used for the epoxy nozzle layer 115 has good formability characteristics, such that the nozzles 117 can be formed with a uniform shape and size in the epoxy nozzle layer 115. Further, the epoxy nozzle layer 115 is formed to have a relatively large thickness of about 20 μm to 30 μm, such that the nozzles 117 can have sufficient length. Therefore, directivity of droplets of the ink ejected through the nozzles 117 can be improved. Furthermore, since the photosensitive epoxy does not react with the ink, the epoxy nozzle layer 115 is not corroded by the ink.

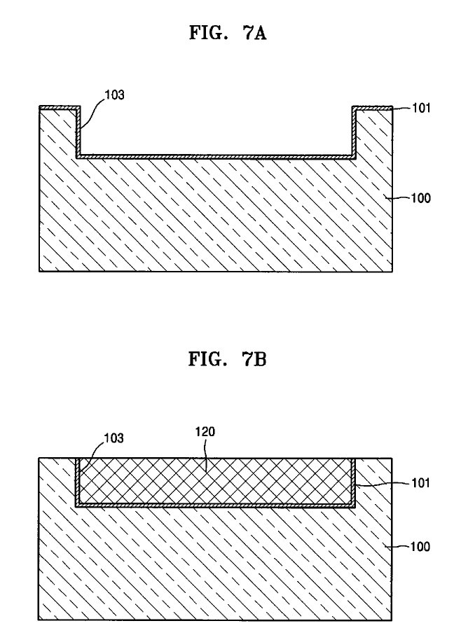

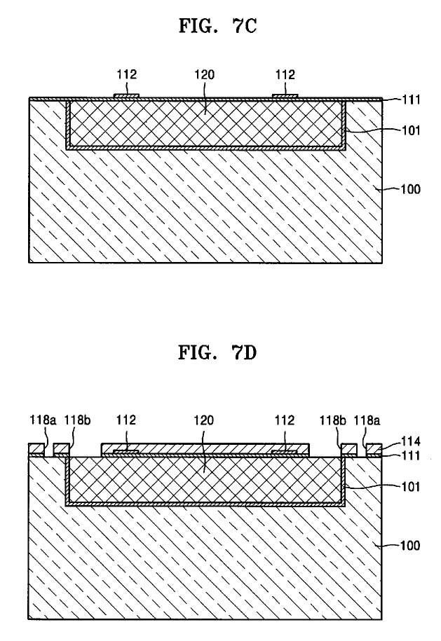

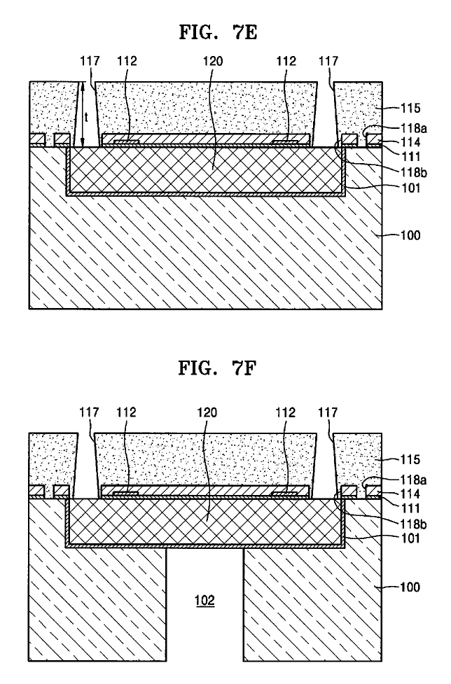

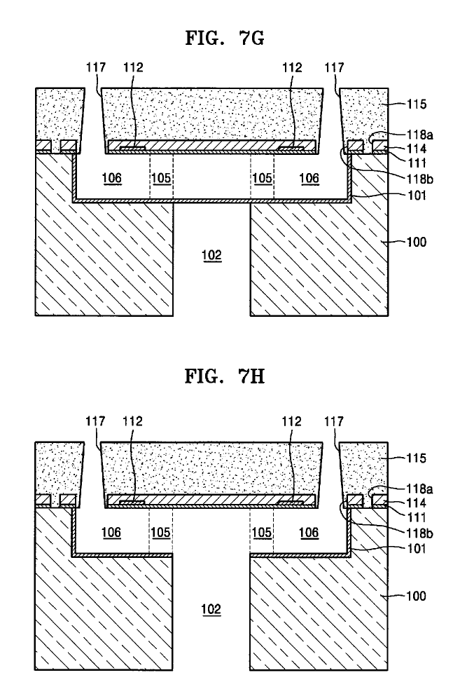

Hereinafter, a method of manufacturing the above-described inkjet printhead will be described. FIGS. 7A through 7H show a method of manufacturing the inkjet printhead according to an embodiment of the present general inventive concept.

Referring to FIG. 7A, a trench 103, in which ink chambers (refer to 106 in FIG. 6) and restrictors (refer to 105 in FIG. 4) are to be defined, is formed in a top surface of a substrate 100 by etching the substrate 100 in a predetermined pattern. Here, a general silicon wafer is used for the substrate 100. Specifically, an etch mask (not shown) is formed on the top surface of the substrate 100 to define a region to be etched, and then the substrate 100, exposed through the etch mask, is etched to form the trench 103 with a predetermined shape. The etching may be carried out using a dry etch method such as reactive ion etching (RIE). Since the trench 103 is formed by etching the top surface of the substrate 100, the trench 103 can have various shapes. Thus, ink chambers and restrictors having desired shapes can be obtained. After the trench 103 is formed, the etch mask is removed from the top surface of the substrate 100. Next, the top surface of the substrate 100, where the trench 103 is formed, is oxidized to form an oxide layer 101 on the top surface of the substrate 100 including the inner surface of the trench 103. The oxide layer 101 may be formed of a silicon oxide.

Referring to FIG. 7B, a sacrifice layer 102 formed of a predetermined material is filled in the trench 103. The sacrificial layer 102 may be formed of polysilicon. Specifically, the polysilicon may be grown on the oxide layer 101 of the substrate 100 by using an epitaxial method to fill the trench 103, and then the top surface of the polysilicon may be planarized through a chemical mechanical polishing (CMP) process. Here, an exposed portion of the oxide layer 101 is also removed to expose the top surface of the substrate 100.

Referring to FIGS. 7C and 7D, passivation layers 111 and 114 are stacked on the top surfaces of the substrate 100 and the sacrificial layer 120, and heaters 112 and conductors (refer to 113 in FIG. 5) are formed between the passivation layers 111 and 114. Specifically, referring to FIG. 7C, a first passivation layer 111 is formed on the top surfaces of the substrate 100 and the sacrificial layer 120. The first passivation layer 111 may be formed by depositing silicon oxide or silicon nitride on the top surfaces of the substrate 100 and the sacrificial layer 120. Next, the heaters 112 are formed on a top surface of the first passivation layer 111. The heaters 112 may be formed by depositing a resistive heating material such as tantalum-aluminium alloy, tantalum nitride, titanium nitride, or tungsten silicide on the top surface of the first passivation layer 111 to a predetermined thickness and patterning the deposited resistive heating material. Next, the conductors 113 are formed on the top surfaces of the heaters 112. The conductors 113 may be formed by depositing metal having a high electrical conductivity such as aluminum (Al), aluminum alloy, gold (Au), or silver (Ag) on the top surfaces of the heaters 112 to a predetermined thickness and patterning the deposited metal.

Referring to FIG. 7D, a second passivation layer 114 is formed on the top surface of the first passivation layer 111 to cover the heaters 112 and the conductors 113. The second passivation layer 114 may be formed by depositing silicon oxide or silicon nitride on the first passivation layer 111. Next, the first and second passivation layers 111 and 114 are patterned using lithography and etching to form nozzle via holes 118b and thermal plugs 118a to expose top surfaces of the sacrifice layer 120 and the substrate 100, respectively. Here, the nozzle via holes 118b are formed where nozzles (refer to 117 in FIG. 4) are to be formed, and the thermal plugs 118a are formed to expose the top surface of the substrate 100 at both sides of the substrate.

Referring to FIG. 7E, an epoxy nozzle layer 115 is formed to cover the first and second passivation layers 111 and 114. Here, the epoxy nozzle layer 115 makes contact with the top surface of the substrate 100 through the thermal plugs 118a, and defines nozzles 117 aligned with the nozzle via holes 118b to expose the top surface of the sacrificial layer 120. The epoxy nozzle layer 115 may have a thickness (t) of about 20 μm to 30 μm. Preferably, the epoxy nozzle layer 115 is formed of a thermally conductive epoxy. Here, the thermally conductive epoxy may be a photosensitive epoxy containing nanoparticles having a high thermal conductivity, such as, metal (e.g., Ag) nanoparticles or ceramic (e.g., aluminum nitride (AlN)) nanoparticles. Specifically, the thermally conductive epoxy is coated on the first and second passivation layers 111 and 114 to a predetermined thickness to fill the nozzle via holes 118b and the thermal plugs 118a, and then the coated epoxy is patterned through lithography to form the epoxy nozzle layer 115. In this process, the nozzles 117 aligned with the nozzle via holes 118b are formed to expose the top surface of the sacrifice layer 120. Here, the nozzles 117 may be tapered toward their ink ejection exit end.

Referring to FIG. 7F, an ink feedhole 102 is formed by etching a bottom surface of the substrate 100. In this process, the oxide layer 101 formed on the bottom of the trench 103 is exposed through the ink feedhole 102. To form the ink feedhole 102, an etch mask (not shown) may be formed on the bottom surface of the substrate 100 to define a region to be etched, and then the substrate 100 exposed through the etch mask may be dry etched or wet etched until the oxide layer 101 is exposed.

Referring to FIG. 7G the sacrificial layer 120 exposed through the nozzles 117 is removed through etching to form ink chambers 106 and restrictors 105. Thus, the ink chambers 106 and the restrictors 105 can be formed parallel to the top surface of the substrate 100 and on the same plane with each other. The ink chambers 106 and the restrictors 105 may be formed by using an etching gas such as XeF₂ gas or BrF₃ to dry etch the sacrificial layer 120 exposed through the nozzles 117. In this process, the oxide layer 101 formed on the inner wall of the trench 103 functions as an etch stop layer.

Finally, referring to FIG. 7H, a portion of the oxide layer 101 located between the restrictors 105 and the ink feedhole 102 is removed through dry etching, thereby completing the manufacturing of the inkjet printhead according to this embodiment of the present general inventive concept.

As described above, the inkjet printhead and the method of manufacturing the same provide that after ink is ejected from the printhead, the heat generated from the heaters can be rapidly dissipated to the substrate through the epoxy nozzle layer which can be formed of a thermally conductive epoxy. Therefore, ink ejecting characteristics can be improved.

In addition, the epoxy nozzle layer can be formed of a photosensitive epoxy that has good formability characteristics, such that nozzles can be formed with a uniform shape and size.

Further, the epoxy nozzle layer can have a relatively high thickness, such that the nozzles can be elongated sufficiently. Therefore, the directivity of ink droplets ejected through the nozzles can be improved.

Further, the epoxy nozzle layer is formed of material that does not react with ink, thereby preventing the epoxy material layer from corrosion by the ink.

Further, the inkjet printhead of the present general inventive concept can be used for array printheads of line printing type inkjet printers as well as for inkjet printheads of shuttle type inkjet printers. Particularly, since a plurality of inkjet printheads are arranged in array printheads and since the heat generated from the heaters is considerably large, the present inventive concept can more effectively dissipate heat when applied to the array printhead environment.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead comprising:
a substrate including an ink chamber formed in a top surface to contain ink to be ejected, an ink feedhole formed in a bottom surface to supply the ink to the ink chamber, and a restrictor formed between the ink chamber and the ink feedhole to connect the ink chamber and the ink feedhole;
a plurality of passivation layers formed on the substrate;
a heater and a conductor formed between the passivation layers, the heater disposed above the ink chamber, the conductor applying current to the heater; and
an epoxy nozzle layer formed of a thermally conductive epoxy to cover the passivation layers, the epoxy nozzle layer being formed with a nozzle connected to the ink chamber.

2. The inkjet printhead of claim 1, wherein the passivation layers define a thermal plug therethrough to expose the top surface of the substrate, and the epoxy nozzle layer is in contact with the substrate through the thermal plug.

3. The inkjet printhead of claim 2, wherein the passivation layers define a nozzle via hole therethrough in alignment with the nozzle, and the epoxy nozzle layer is formed to cover an inner wall of the nozzle via hole.

4. The inkjet printhead of claim 2, wherein the thermally conductive epoxy is a photosensitive epoxy containing thermally conductive nanoparticles.

5. The inkjet printhead of claim 4, wherein the thermally conductive nanoparticles are formed of metal or ceramic.

6. The inkjet printhead of claim 5, wherein the metal includes Ag.

7. The inkjet printhead of claim 5, wherein the ceramic includes AlN (aluminum nitride).

8. The inkjet printhead of claim 2, wherein the epoxy nozzle layer has a thickness of 20 μm to 30 μm.

9. The inkjet printhead of claim 2, wherein the passivation layers include a first passivation layer and a second passivation layer that are sequentially stacked on the substrate, the heater is formed between the first and second passivation layers, and the conductor is formed between the heater and the second passivation layer.

10. The inkjet printhead of claim 9, wherein the first and second passivation layers are formed of silicon oxide or silicon nitride.

11. The inkjet printhead of claim 2, wherein the restrictor is formed on the same plane as the ink chamber.

12. The inkjet printhead of claim 11, wherein the ink chamber and the restrictor include inner walls formed with oxide layers.

13. The inkjet printhead of claim 2, wherein the nozzle has a taper shaped side section that becomes narrower toward an exit end of the nozzle.

14. A method of manufacturing an inkjet printhead, comprising:
forming a trench in a top surface of a substrate to define an ink chamber and a restrictor, and forming an oxide layer on the top surface of the substrate including an inner wall of the trench;
filling the trench with a sacrificial layer being formed of a predetermined material;
stacking passivation layers on the substrate and the sacrificial layer, and forming a heater and a conductor between the passivation layers;
patterning the passivation layers to form a nozzle via hole exposing a top surface of the sacrificial layer and a thermal plug exposing the top surface of the substrate;
forming an epoxy nozzle layer of a thermally conductive epoxy to cover the passivation layers, the epoxy nozzle layer defining a nozzle therethrough in alignment with the nozzle via hole to expose the top surface of the sacrificial layer;
forming an ink feedhole by etching a bottom surface of the substrate to expose the oxide layer formed on a bottom of the trench;
forming the ink chamber and the restrictor by removing the sacrificial layer exposed through the nozzle; and
removing a portion of the oxide layer that is located between the ink feedhole and the restrictor.

15. The method of claim 14, wherein the substrate is formed of a silicon wafer.

16. The method of claim 15, wherein the oxide layer is formed of silicon oxide.

17. The method of claim 14, wherein the sacrificial layer is formed of polysilicon.

18. The method of claim 17, wherein the filling of the trench includes:
growing the polysilicon on the oxide layer of the substrate using an epitaxial method to fill the trench; and
planarizing a top surface of the poly silicon through a CMP (chemical mechanical polishing) process to expose the top surface of the substrate.

19. The method of claim 14, wherein the stacking of the passivation layers and the forming of the heater and the conductor include:
forming a first passivation layer on the top surfaces of the substrate and the sacrificial layer;
forming the heater on a top surface of the first passivation layer and forming the conductor on a top surface of the heater; and
forming a second passivation layer on the top surface of the first passivation layer to cover the heater and the conductor.

20. The method of claim 19, wherein the first and second passivation layers are formed of silicon oxide or silicon nitride.

21. The method of claim 14, wherein the forming of the epoxy nozzle layer includes:
coating the passivation layers with the thermally conductive epoxy to fill the nozzle via hole and the thermal plug; and
forming the nozzle in alignment with the nozzle via hole by patterning the thermally conductive epoxy through a lithographic process.

22. The method of claim 21, wherein the epoxy nozzle layer is formed to a thickness of 20 μm to 30 μm.

23. The method of claim 21, wherein the thermally conductive epoxy is a photosensitive epoxy containing thermally conductive nanoparticles.

24. The method of claim 23, wherein the thermally conductive nanoparticles are formed of metal or ceramic.

25. The method of claim 24, wherein the metal includes Ag.

26. The method of claim 24, wherein the ceramic includes AlN (aluminum nitride).

27. The method of claim 14, wherein the forming of the ink chamber and the restrictor is carried out by removing the sacrificial layer through dry etching.

28. The method of claim 14, wherein the removing of the portion of the oxide layer is carried out through dry etching.
